(19) United States
(12) Patent Application Publication
(10) Pub. No.: US 2012/0083978 A1
(43) Pub. Date: Apr. 5, 2012

(54) CONTROL DEVICE FOR AUTOMATIC TRANSMISSION

(75) Inventors: Yoichi Tajima, Anjo (JP); Yomei Hakumura, Toyokawa (JP)

(73) Assignee: AISIN AW CO., LTD., Anjo-shi (JP)

(21) Appl. No.: 13/238,982

(22) Filed: Sep. 21, 2011

(30) Foreign Application Priority Data
Sep. 30, 2010 (JP) 2010-220824

(51) Int. Cl. F16H 61/30

(52) U.S. Cl. 701/55

(57) ABSTRACT

A control device for an automatic transmission configured with a command output portion that outputs a command that causes an electric pump to be driven so that oil pressure generated by the mechanical pump and the electric pump becomes greater than or equal to a needed oil pressure for a speed change mechanism when the oil pressure generated by the mechanical pump is smaller than the needed oil pressure. A determination portion determines whether or not a predetermined heat generation condition is met when the command is output by the command output portion. A shift control portion that, in a case where the determination portion has determined that the heat generation condition is met, performs a shift control of causing the speed ratio of the speed change mechanism to become higher than the speed ratio occurring when the determination portion determines that the heat generation condition is met.

### INCORPORATION BY REFERENCE

The disclosure of Japanese Patent Application No. 2010-220824 filed on Sep. 30, 2010 including the specification, drawings and abstract is incorporated herein by reference in its entirety.

### BACKGROUND OF THE INVENTION

The present invention relates to a control device for an automatic transmission and, more particularly, to a control device for an automatic transmission that has an electric pump and a mechanical pump.

### DESCRIPTION OF THE RELATED ART

There is known a vehicle equipped with an automatic transmission that is furnished with pumps for generating oil pressure for performing control of a speed change mechanism which are a mechanical pump that is driven by rotation drive force provided by a drive force source, and an electric pump that is driven independently of the mechanical pump (e.g., refer to Japanese Patent Application Publication No. JP-A-2009-74592). As such a vehicle, for example, a hybrid vehicle furnished with an engine and a motor-generator as drive force sources, or the like is applied.

In the foregoing vehicle, for example, in the case where during the traveling of the vehicle, the rotation speed of the drive force source (i.e., the rotation speed of the mechanical pump) is less than an idling rotation speed (in the number of rotations per unit time), the electric pump is driven to assist the mechanical pump. As for this vehicle, it is described that, as a countermeasure against the heat generation of the electric pump, when the heat generation of the electric pump is detected, the oil pressure generated by the mechanical pump is raised by increasing the rotation speed of the drive force source, so that the load on the electric pump is reduced.

### SUMMARY OF THE INVENTION

However, in the foregoing related art, in the vehicle, the oil pressure generated by the mechanical pump is raised by increasing the rotation speed of the drive force source, so that the load on the electric pump is reduced, as a countermeasure against the heat generation. However, the rotation speed of the drive force source rises independently of the operation performed by a driver of the vehicle or changes of the environment in which the vehicle travels, and, following the rise, the rotation speed of an output shaft of the speed change mechanism rises. Therefore, there is a possibility of giving an uncomfortable feeling to the driver of the vehicle. Incidentally, the foregoing problem is a common problem for not only hybrid vehicles but also other kinds of vehicles that have a mechanical pump and an electric pump.

An object of the present invention is to provide a technology capable of taking a countermeasure against the heat generation of an electric pump while restraining the uncomfortable feeling caused to a driver, in an automatic transmission that is capable of driving the electric pump during a state in which the rotation speed of the drive force source is higher than or equal to the idling rotation speed.

The present invention has been accomplished in order to solve at least part of the foregoing problems, and can be realized as the following forms or application examples.

A first aspect of the present invention relates to a control device for an automatic transmission that changes rotation speed transferred from a drive force source of a vehicle to an input shaft and then transfers the rotation speed to the output shaft, and that has: a speed change mechanism that changes a speed ratio that represents a ratio of the rotation speed of the input shaft to the rotation speed of the output shaft by utilizing oil pressure; a mechanical pump that is driven by rotation of the input shaft and that generates the oil pressure for changing the speed ratio of the speed change mechanism; and an electric pump that is driven independently of the drive force source by using electric power and that generates the oil pressure for changing the speed ratio of the speed change mechanism together with the generated oil pressure from the mechanical pump. The control device for the automatic transmission includes:

a command output portion that outputs a command that causes the electric pump to be driven so that the oil pressure generated by the mechanical pump and the electric pump becomes greater than or equal to a needed oil pressure of the speed change mechanism in a case where the oil pressure generated by the mechanical pump is smaller than the needed oil pressure;

a determination portion that determines whether or not a predetermined heat generation condition regarding the electric pump is met, in a case where the command is output by the command output portion; and

a shift control portion that, in a case where the determination portion has determined that the heat generation condition is met, performs a shift control of causing the speed ratio of the speed change mechanism to become higher than the speed ratio occurring when the determination portion determines that the heat generation condition is met.

With the control device for the automatic transmission according to the first aspect, in the case where the determination portion has determined that the heat generation condition is met, the speed ratio of the speed change mechanism is caused to be higher than the speed ratio occurring when the determination portion determines that the heat generation condition is met, so that the rotation speed of the drive force source (the input shaft) can be increased and the oil pressure generated by the mechanical pump can be increased. Therefore, in the case where the heat generation condition regarding the electric pump is met, the load on the electric pump assisting the mechanical pump can be reduced. As a result, the heat generation of the electric pump can be restrained. Besides, according to the control device for the automatic transmission having the foregoing structure, in the case where the determination portion has determined that the heat generation condition is met, the speed ratio of the speed change mechanism is caused to be higher than the speed ratio occurring when the determination portion determines that the heat generation condition is met. Therefore, it is possible to restrain rise in the rotation speed of the output shaft of the speed change mechanism while increasing the rotation speed of the drive force source (the input shaft). As a result, it is possible to restrain an uncomfortable feeling from being given to the driver of the vehicle. Besides, since the rotation speed of the drive force source is increased by increasing the speed ratio, the uncomfortable feeling associated with the increase of the rotation speed of the drive force source independent of operation of the driver of the vehicle and changes of the environment in which the vehicle travels can be restrained from being given to the driver of the vehicle. As in the above, according to the control device for the automatic transmission having the foregoing structure, in the case where the determination portion has determined that the heat generation condition is met, it is possible to restrain an uncomfortable feeling from being given to the driver of the vehicle and perform a countermeasure against the heat generation of the electric pump.

Incidentally, the control device for the automatic transmission according to the first aspect may include:

a first oil pressure calculation portion that calculates the needed oil pressure of the speed change mechanism;

a second oil pressure calculation portion that calculates the oil pressure generated by the mechanical pump, and

the command output portion may be designed so that in the case where the oil pressure calculated by the second oil pressure calculation portion is smaller than the needed oil pressure calculated by the first oil pressure calculation portion, the command output portion outputs a command that causes the electric pump to be driven so that the oil pressure generated by the mechanical pump and the electric pump becomes equal to the needed oil pressure.

According to a second aspect of the present invention, the control device for the automatic transmission according to the first aspect may be configured such that

the determination portion determines whether or not a discontinuation condition that allows it to be considered that degree of heat generation of the electric pump has declined is met, after the shift control portion performs the shift control of causing the speed ratio of the speed change mechanism to become higher, and

the shift control portion shifts to a speed ratio that is proper in a state of the vehicle, in a case where the determination portion has determined that the discontinuation condition is met.

According to the second aspect, in the case where after the shift control portion performs the shift control of causing the speed ratio of the speed change mechanism to become higher, the discontinuation condition that allows it to be considered that the degree of heat generation of the electric pump has declined is met, the speed ratio is shifted to a speed ratio that is optimum for the state of the vehicle. Specifically, in the case where the degree of heat generation of the electric pump has declined, it is possible to shift, to the electric pump, a portion of the load related to oil pressure generation that the mechanical pump MP bears by shifting the increased speed ratio to a speed ratio that is proper for the state of the vehicle. Therefore, the driving of the drive force source for the purpose of raising the rotation speed of the mechanical pump can be reduced by an amount that corresponds to the driving of the electric pump. As a result, improvement of the fuel economy of the vehicle can be expected.

According to a third aspect of the present invention, the control device for the automatic transmission according to the first or second aspect may be configured such that

the shift control portion is capable of executing:

a first shift control of performing the shift control based on a first shift map that includes a plurality of shift lines defined by a relationship between vehicle speed and demanded torque; and

a second shift control of performing the shift control based on a second shift map which includes a plurality of shift lines defined by a relationship between the vehicle speed and the demanded torque, and in which at least a portion of each shift line is shifted to a high vehicle speed side of a corresponding one of the shift lines of the first shift map so that the rotation speed of the input shaft commensurate with the speed ratio determined based on the vehicle speed and the demanded torque is higher than the rotation speed of the input shaft commensurate with the speed ratio determined based on the vehicle speed and the demanded torque with reference to the first shift map, and that

in a case where during execution of the first shift control, the determination portion has determined that the heat generation condition is met, the control device executes the second shift control in place of the first shift control.

With the control device for the automatic transmission according to the third aspect, in the case where during the execution of the shift control based on the first shift map, the heat generation condition regarding the electric pump is met, the shift control is switched to the shift control based on the second shift map in which each shift line is shifted to the high vehicle speed side of the corresponding shift line of the first shift map so that the rotation speed of the input shaft commensurate with the speed ratio determined on the basis of the vehicle speed and the demanded torque is higher than the rotation speed of the input shaft commensurate with the speed ratio determined on the basis of the vehicle speed and the demanded torque with reference to the first shift map. As a result, decline in the oil pressure generated by the mechanical pump is restrained. Therefore, in the case where during the execution of the shift control based on the first shift map, the heat generation condition regarding the electric pump is met, the load on the electric pump assisting the mechanical pump can be reduced. As a result, the heat generation of the electric pump can be restrained. Besides, no matter which one of the speed ratios the present speed ratio is during the execution of the shift control based on the first shift map, the speed ratio can easily be increased to increase the rotation speed of the drive force source (the input shaft) by switching to the shift control based on the second shift map. Therefore, with this structure, the heat generation of the electric pump can be restrained by a simpler control.

According to a fourth aspect of the present invention, the control device for the automatic transmission according to the third aspect may be configured such that

in the second shift map, the plurality of shift lines are set so that the needed oil pressure that the speed change mechanism needs is able to be secured by using the mechanical pump without driving the electric pump.

According to the fourth aspect, in the case where the heat generation condition regarding the electric pump is met, the needed oil pressure can be secured by using only the mechanical pump, and therefore the electric pump can be stopped. As a result, the heat generation of the electric pump can be prevented.

Incidentally, the control device for the automatic transmission according to the fourth aspect may adopt the following structure:

a control device for the automatic transmission, wherein

the speed change mechanism has a plurality of friction engagement elements whose state of engagement is capable of being changed by utilizing the oil pressure, and is capable of accomplishing a plurality of shift speeds that differ in the speed ratio, according to the states of engagement of the plurality of friction engagement elements,

the shift control is a control of accomplishing one of the plurality of shift speeds, and

in the case where the determination portion has determined that the heat generation condition is met during a state in which, of the plurality of shift speeds, one of the shift speeds excluding the lowest speed-side shift speed has been accomplished, the shift control portion shifts the shift speed to a lower-side shift speed.

According to the control device for the automatic transmission having the foregoing structure, since a so-called downshift is performed when the heat generation condition regarding the electric pump is met, the rotation speed of the input shaft can be increased to increase the oil pressure generated by the mechanical pump. As a result, when the heat generation condition regarding the electric pump is met, the load on the electric pump assisting the mechanical pump can be reduced. Therefore, the heat generation of the electric pump can be restrained.

Incidentally, the present invention can be realized in various forms; for example, the present invention can be realized in forms such as a control program for an automatic transmission, a recording medium in which the control program is recorded, a control method for an automatic transmission, a vehicle furnished with an automatic transmission, etc.

### BRIEF DESCRIPTION OF THE DRAWINGS

FIG. 1 is a diagram schematically showing a structure of a vehicle 1000 as an embodiment of the present invention;

FIG. 2 is a diagram showing a functional block of an ECU 200;

FIG. 3 is a skeleton diagram showing a mechanical structure of a speed change mechanism 5;

FIG. 4 is an operation table of the speed change mechanism 5;

FIG. 5 is a diagram schematically showing a structure of a speed change mechanism control valve SLC;

FIGS. 6A and 6B are schematic diagrams showing shift maps;

FIG. 7 is a flowchart of a shift map setting process that the ECU 200 performs;

FIG. 8 is a diagram schematically showing a structure of a vehicle 1000A according to a second embodiment;

FIG. 9 is a diagram schematically showing a structure of a vehicle 1000B according to a third embodiment; and

FIG. 10 is a flowchart showing process steps of a shift control setting process that is performed in a fourth embodiment.

### DETAILED DESCRIPTION OF THE EMBODIMENTS

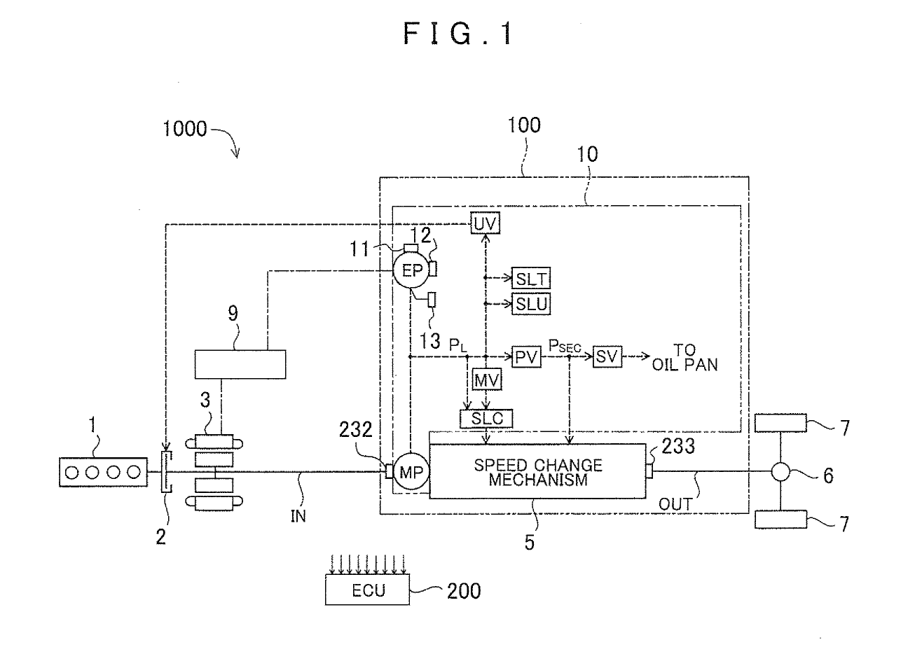

Next, modes for carrying out the invention will be described on the basis of embodiments with reference to FIG. 1 to FIG. 9.

### A. First Embodiment

### A1. Structure of Vehicle

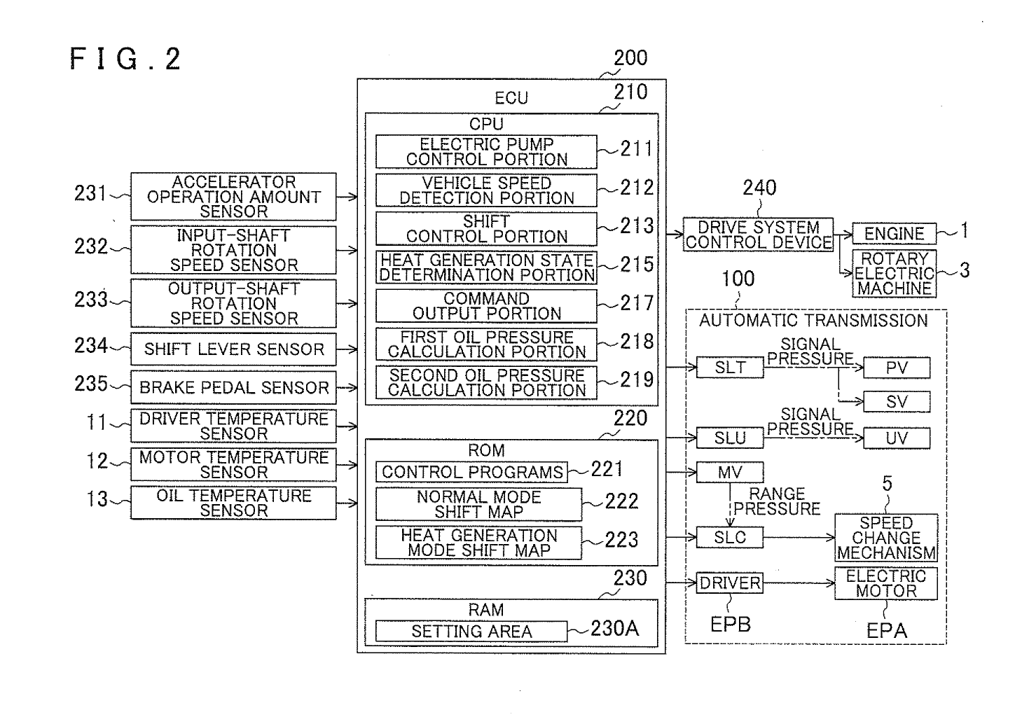

FIG. 1 is a diagram schematically showing a structure of a vehicle 1000 as an embodiment of the present invention. In FIG. 1, structures related to the vehicle 1000 are selectively shown in order to avoid complications of the drawing. Incidentally, in FIG. 1, solid lines show transfer paths of drive force, and interrupted lines show supply paths of an operating oil ATF (Automatic Transmission Fluid), and a one-dot chain line shows electrical connection. FIG. 2 is a diagram showing functional blocks of an electronic control unit 200 (also termed the ECU (Electric Control Unit)).

The vehicle 1000 of this embodiment is a hybrid vehicle that uses an engine and a motor as drive force sources. This vehicle 1000, as shown in FIG. 1 or FIG. 2, is furnished with an engine 1, a transfer clutch 2, a rotary electric machine 3, a differential device 6, wheels 7, an electricity storage device 9, an input shaft IN, an output shaft OUT, an automatic transmission 100, the ECU 200, an accelerator operation amount sensor 231, an input-shaft rotation speed sensor 232, an output-shaft rotation speed sensor 233, a shift lever sensor 234, a brake pedal sensor 235, and a drive system control device 240. In this embodiment, the rotation speed shows the number of rotations per unit time.

The automatic transmission 100 is furnished with an oil pressure control device 10 and a speed change mechanism 5. These structures will be described in detail later.

The engine 1, the transfer clutch 2, the rotary electric machine 3 and the speed change mechanism 5 are connected in that order via the input shaft IN. The engine 1 and the rotary electric machine 3 are linked in series via the transfer clutch 2. The speed change mechanism 5 is connected to the output shaft OUT. The input shaft IN and the output shaft OUT function as drive force transmission paths.

The engine 1 is a multi-cylinder gasoline engine, and transfers drive force for driving the vehicle 1000 to the input shaft IN, which is an output shaft of the engine 1. Besides, the rotary electric machine 3 is capable of functioning as both a motor (electric motor) and a generator (electricity generator). In the case where the rotary electric machine 3 functions as a motor, the rotary electric machine 3 transfers the drive force for driving the vehicle 1000 to the input shaft IN.

The rotary electric machine 3 is electrically connected to an electricity storage device 9, and functions as a motor when supplied with electric power from the electricity storage device 9, and functions as a generator during a state in which the rotary electric machine 3 is not supplied with electric power from the electricity storage device 9 and drive force is transferred from the input shaft IN. The electricity storage device 9 is formed of a battery, a capacitor, etc.

The transfer clutch 2 receives supply of an operating oil from the oil pressure control device 10 (a transfer clutch control valve UV described later), and is controlled to an engaged state or a released state.

When the vehicle 1000 of this embodiment starts, or travels at low speeds, the transfer clutch 2 is controlled to the released state, and the engine 1 is controlled to a stopped state, and the vehicle 100 travels by drive force that is generated by the rotary electric machine 3. In this case, the rotary electric machine 3 generates drive force by receiving supply of electric power from the electricity storage device 9, and transfers the drive force to the input shaft IN. In this vehicle 1000, when the rotation speed of the rotary electric machine 3 reaches or exceeds a certain level, that is, when the traveling speed of the vehicle 1000 (hereinafter, also termed the vehicle speed) reaches or exceeds a certain level, the engine 1 is started, and the transfer clutch 2 is controlled to the engaged state, so that the drive force of the engine 1 is transferred to the input shaft IN. This vehicle 1000 travels mainly by the drive force of the engine 1 when the vehicle speed reaches or exceeds a certain level. In this case, the rotary electric machine 3 assumes either one of a state of generating electricity by drive force from the engine 1 and a state of generating drive force by receiving supply of electric power from the electricity storage device 9, depending on the state of charge of the electricity storage device 9. Besides, when this vehicle 1000 decelerates, the transfer clutch 2 is controlled to the released state and the engine 1 is controlled to the stopped state. In this case, the rotary electric machine 3 assumes the state of generating electricity by drive force transferred from the wheels 7. The electric power generated by the rotary electric machine 3 is stored into the electricity storage device 9. When this vehicle 1000 is at a stop, the engine 1 and the rotary electric machine 3 are controlled to the stopped state, and the transfer clutch 2 is controlled to the released state.

The differential device 6 is disposed between the output shaft OUT and the wheels 7, and transfers the drive force transferred from the output shaft OUT to each of the two wheels 7, and adjusts the rotation speed difference that occurs between the two wheels 7.

The accelerator operation amount sensor 231 sends to the ECU 200 an accelerator operation amount signal that represents the accelerator operation amount of an accelerator pedal (not shown). Incidentally, the accelerator operation amount can also be referred to as a torque request made by a driver. The input-shaft rotation speed sensor 232 sends to the ECU 200 an input-shaft rotation speed signal that represents the rotation speed of the input shaft IN, that is, the rotation speed of a mechanical pump MP. The output-shaft rotation speed sensor 233 sends to the ECU 200 an output-shaft rotation speed signal that represents the rotation speed of the output shaft OUT. The shift lever sensor 234 sends to the ECU 200 a shift position signal that shows the position of a shift lever (not shown). The brake pedal sensor 235 sends to the ECU 200 a brake operation amount signal that shows the amount of operation (amount of depression) of a brake pedal (not shown).

[Description of Speed Change Mechanism]

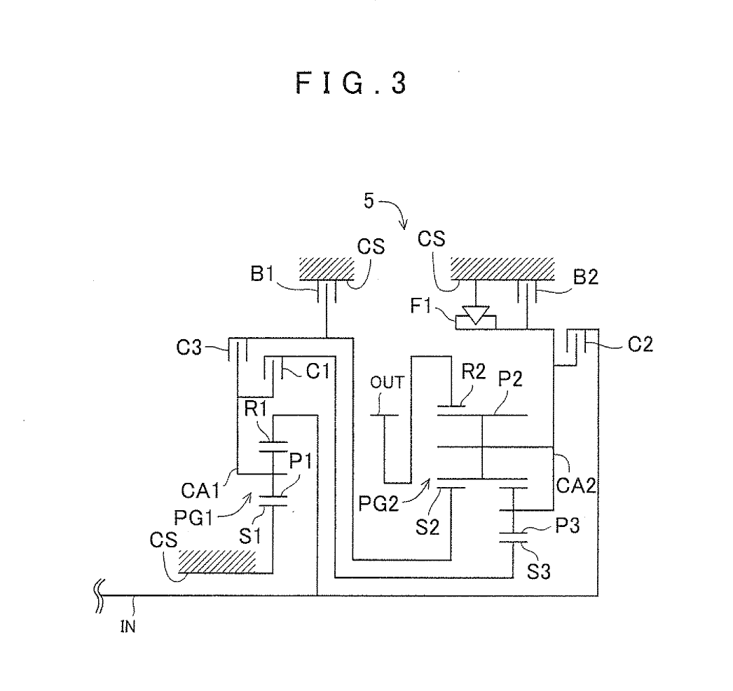

FIG. 3 is a skeleton diagram showing a mechanical structure of the speed change mechanism 5. Illustration of substantially lower half of the speed change mechanism 5 is omitted in FIG. 3.

The speed change mechanism 5 is connected to the input shaft IN and the output shaft OUT. The speed change mechanism 5, as shown in FIG. 3, is structured as a six-speed stepped speed change mechanism, and is furnished with a single pinion type planetary gear mechanism PG1, a Ravigneaux type planetary gear mechanism PG2, three clutches C1, C2 and C3, two brakes B1 and B2, and a one-way clutch F1 The single type planetary gear mechanism PG1 is furnished with a sun gear S1 as an external gear, a ring gear R1 as an internal gear that is disposed concentrically with the sun gear S1, a plurality of pinions P1 meshing with the sun gear S1 and meshing with the ring gear R1, and a carrier CA1 that holds the pinions P1 so that the pinions P1 are freely rotatable about their own axes and freely revolvable about an axis. The sun gear S1 is fixed to a case CS, and the ring gear R1 is connected to the input shaft IN. The Ravigneaux type planetary gear mechanism PG2 is furnished with two sun gears S2 and S3 that are external gears, a ring gear R2 that is an internal gear, a plurality of short pinions P3 meshing with the sun gear S3, a plurality of long pinions P2 meshing with the sun gear S2 and the short pinions P3 and also meshing with the ring gear R2, and a carrier CA2 that links the short pinions P3 and the long pinions P2 and holds the short and long pinions P3 and P2 so that the pinions are freely rotatable about their own axes and revolvable about the axis. The sun gear S3 is connected to the carrier CA1 of the planetary gear mechanism PG1 via the clutch C1, and the sun gear S2 is connected to the carrier CA1 via the clutch C3 and also connected to the case CS via the brake B1. The ring gear R2 is connected to the output shaft OUT, and the carrier CA2 is connected to the input shaft IN via the clutch C2. Besides, the carrier CA2 is connected to the case CS via the one-way clutch F1, and is also connected to the case CS via the brake B2 that is provided in parallel with the one-way clutch F1.

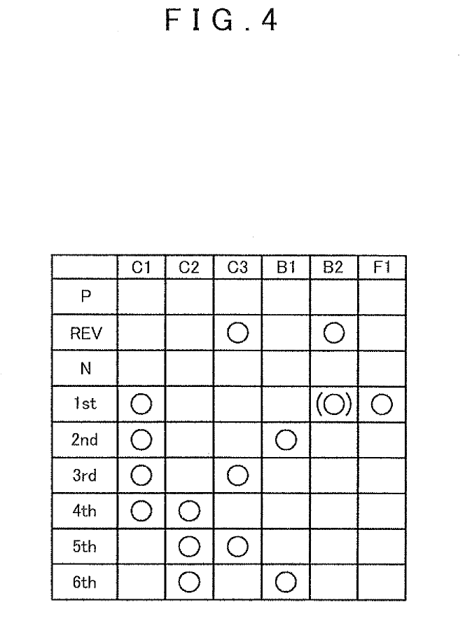

The speed change mechanism 5, as shown in FIG. 4, is designed so as to be able to switch among the first to sixth forward speeds, the reverse and the neutral due to the on and off-states (engagement and release) of the clutches C1 to C3 and the on and off-states of the brakes B1 and B2. The state of the reverse can be formed by turning on the clutch C3 and the brake B2 and turning off the clutches C1 and C2 and the brake B1. Besides, the state of the first forward speed can be formed by turning on the clutch C1 and turning off the clutches C2 and C3 and the brakes B1 and B2. During the state of the first forward speed, the brake B2 is turned on instead of the one-way clutch F1 at the time of engine braking. The state of the second forward speed can be formed by turning on the clutch C1 and the brake B1 and turning off the clutches C2 and C3 and the brake B2. The state of the third forward speed can be formed by turning on the clutches C1 and C3 and turning off the clutch C2 and the brakes B1 and B2. The state of the fourth forward speed can be formed by turning on the clutches C1 and C2 and turning off the clutch C3 and the brakes B1 and B2. The state of the fifth forward speed can be formed by turning on the clutches C2 and C3 and turning off the clutch C1 and the brakes B1 and B2. The state of the sixth forward speed can be formed by turning on the clutch C2 and the brake B1 and turning off the clutches C1 and C3 and the brake B2. Besides, the state of the neutral can be formed by turning off all the clutches C1 to C3 and the brakes B1 and B2.

[Description of Oil Pressure Control Device]

The oil pressure control device 10, as shown in FIG. 1, is furnished with an electric pump EP, a mechanical pump MP, a primary regulator valve PV, a secondary regulator valve SV, a manual shift valve MV, a linear solenoid valve SLT, a linear solenoid valve SLU, a transfer clutch control valve UV, a speed change mechanism control valve SLC, a driver temperature sensor 11, a motor temperature sensor 12, and an oil temperature sensor 13.

The mechanical pump MP is driven by rotational drive force of the input shaft IN, and is a pump for generating an oil pressure for changing the shift speed (speed ratio) of the speed change mechanism 5. The mechanical pump MP generates oil pressure by sucking up the operating oil from an oil pan via a strainer (not shown) on the basis of the rotational drive force of the input shaft IN. Incidentally, the speed ratio represents the rotation speed of the input shaft IN relative to the rotation speed of the output shaft OUT. That is, the speed ratio is expressed by the following expression. speed ratio−(rotation speed of input shaft IN)/(rotation speed of output shaft OUT)

The electric pump EP is a pump for assisting the mechanical pump MP, and is driven in a situation where a needed oil pressure (necessary line pressure P_{L}) cannot be secured by using only the mechanical pump MP. The electric pump EP includes an electric motor EPA and a driver EPB. The electric pump EP generates oil pressure by sucking up the operating oil from the oil pan via a strainer (not shown) because the driver EPB, when receiving supply of electric power from the electricity storage device 9 and receiving a command from the ECU 200 (a command output portion 217 described later), drives the electric motor EPA. Herein the “situation where a needed oil pressure cannot be secured”, that is, the situation where the electric pump EP is driven, refers to, for example, situations as follows.

Situation 1: where the rotation speed of the mechanical pump MP is lower than a predetermined value.
Situation 2: where large transfer torque occurs on a friction engagement element such as any of the various clutches or brakes of the speed change mechanism 5 as well as the transfer clutch 2 or the like. For example, when the vehicle 1000 rapidly accelerates, when the vehicle 1000 rapidly decelerates, and when the vehicle 1000 is traveling up a hill.

The primary regulator valve PV regulates the oil pressure generated by the mechanical pump MP and the electric pump EP to a line pressure P_{L} on the basis of a signal pressure output from the linear solenoid valve SLT. As for the linear solenoid valve SLT, when the line pressure P_{L} regulated by the primary regulator valve PV is input to the valve and the degree of opening of the valve is adjusted on the basis of a command value from the ECU 200, the valve SLT outputs a signal pressure commensurate with the command value to the primary regulator valve PV and the secondary regulator valve SV. The line pressure P_{L} is input not only to the linear solenoid valve SLT but also to the manual shift valve MV, the linear solenoid valve SLU, the transfer clutch control valve UV, the speed change mechanism control valve SLC (linear solenoid valve SLC3 described later), etc. In the automatic transmission 100, the necessary line pressure P_{L} (needed oil pressure) changes depending on various situations that include the aforementioned situations 1 and 2.

As for the linear solenoid valve SLU, when the line pressure P_{L} regulated by the primary regulator valve PV is input to the valve and the degree of opening of the valve is adjusted on the basis of a command value from the ECU 200, the valve SLU outputs a signal pressure commensurate with the command value to the transfer clutch control valve UV. The transfer clutch control valve UV transfers the oil pressure commensurate with the signal pressure output from the linear solenoid valve SLU to a hydraulic servo (not shown) of the transfer clutch 2, thereby controlling the engagement force of the transfer clutch 2.

The secondary regulator valve SV regulates the oil pressure discharged from the primary regulator valve PV to a secondary pressure P_{SEC}. The secondary pressure P_{SEC} is transferred to a lubricating oil path of the speed change mechanism 5, an oil cooler (not shown), etc.

The manual shift valve MV has a spool (not shown) that is mechanically or electrically driven according to the position of the shift lever that is provided at a driver's seat. The position of the spool of the manual shift valve MV is switched according to the position of the shift lever (i.e., a selected shift range (e.g., a parking range (P range), a reverse drive range (R range), a neutral range (N range), or a forward drive range (D range)). The manual shift valve MV is structured so as to switch the state of outputting the line pressure P_{L} supplied and the state of non-output thereof (drain) according to the position of the spool.

Concretely, when the position of the shift lever is in the forward drive range (D range), the spool of the manual shift valve MV is set at a position at which an input port of the manual shift valve MV (where the line pressure P_{L} is input) and a forward range pressure output port thereof communicate with each other. As a result, the line pressure P_{L} is output from the forward range pressure output port of the manual shift valve MV as a forward range pressure (D range pressure) P_{D}. When the position of the shift lever is set in the reverse drive range (R range), the spool of the manual shift valve is set at a position at which the input port and a reverse range pressure output port communicate with each other. As a result, the line pressure P_{L} is output from the reverse range pressure output port of the manual shift valve MV as a reverse range pressure (R range pressure) P_{REV}. The position of the shift lever is in the parking range (P range) or the neutral range (N range), the spool of the manual shift valve MV is set at a position at which the input port, the forward range pressure output port and the reverse range pressure output port are shut off from each other and the forward range pressure output port, the reverse range pressure output port and the drain port communicate with each other. This results in a non-output state in which the forward range pressure P_{D} and the reverse range pressure P_{REv} have been drained (discharged).

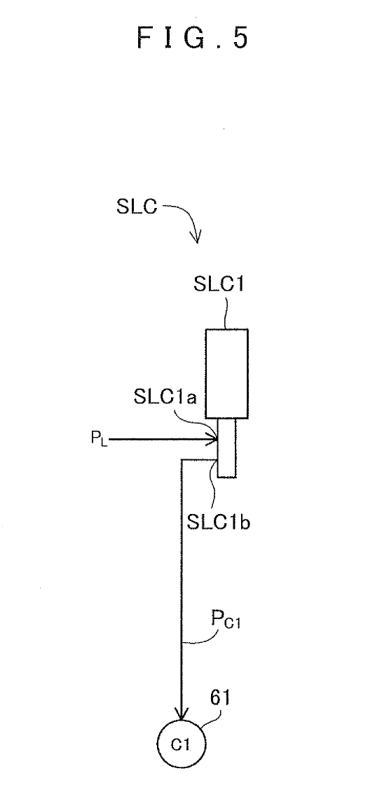

FIG. 5 is a diagram schematically showing a structure of the speed change mechanism control valve SLC. The speed change mechanism control valve SLC adjusts the oil pressure of the operating oil in order to perform a shift control, and supplies it to the speed change mechanism 5. This speed change mechanism control valve SLC is a control valve for regulating control pressures P_{C1}, P_{C2}, P_{C3}, P_{B1} and P_{B2} and transferring them to hydraulic servos of the clutch C1 to C3 and the brakes B1 and B2, respectively, and is furnished with a plurality of linear solenoid valves (e.g., a linear solenoid valve SLC1). In FIG. 5, a structure related to the clutch C1 is representatively shown.

As shown in FIG. 5, the line pressure P_{L} regulated by the primary regulator valve PV is transferred to an input port SLC1a of the linear solenoid valve SLC1. The linear solenoid valve SLC1 is of a normally open type that assumes a non-output state when not electrified, and regulates the forward range pressure P_{L} supplied to the input port SLC1a and outputs from an output port SLC1b a control pressure P_{C1} provided so as to be transferred to the hydraulic servo 61 of the clutch C1. The linear solenoid valve SLC1 is structured to adjust the amount of communication (amount of opening) between the input port SLC1a and the output port SLC1b on the basis of a command value from the ECU 200 and to thus output the control pressure P_{C1} commensurate with the command value. The ECU 200 controls the clutch C1 to the engaged state by controlling the control pressure P_{C1} to or above a predetermined threshold value, and controls the clutch C1 to the released state by controlling the control pressure P_{C1} to or below a threshold value. Structures related to the other friction engagement elements are substantially the same as those related to the clutch C1, and therefore their illustrations and descriptions will be omitted. The ECU 200 is able to control the engagement and release of each of the friction engagement elements similarly to the clutch C1, by controlling a corresponding one of the control pressures P_{C1}, P_{C2}, P_{C3}, P_{B1} and P_{B2}.

The driver temperature sensor 11 is disposed at the driver EPB of the electric pump EP, and sends to the ECU 200 a driver temperature signal that represents the temperature of the driver EPB (e.g., a transistor temperature). Hereinafter, the temperature of the driver EPB will also be termed the driver temperature.

The motor temperature sensor 12 is disposed at the electric motor EPA of the electric pump EP, and sends to the ECU 200 a motor temperature signal that represents the temperature of the electric motor EPA (e.g., a coil temperature). Hereinafter, the temperature of the electric motor EPA will also be termed the motor temperature.

The oil temperature sensor 13 is disposed at a discharge port (not shown) of the electric pump EP, and sends to the ECU 200 an oil temperature signal that represents the oil temperature of the operating oil discharged from the electric pump EP. Hereinafter, the oil temperature of the operating oil discharged from the electric pump EP will also be termed the discharged-oil temperature.

[Description of ECU]

Next, with reference to FIG. 2 again, the ECU 200, which functions as a control device for the automatic transmission 100, will be described. The ECU 200 is structured to be capable of controlling the linear solenoid valves by sending command values as electric signals (control signals) to the aforementioned linear solenoid valves of the speed change mechanism control valve SLC that correspond to the friction engagement elements (the linear solenoid valve SLC1 shown in FIG. 5, and the like), the linear solenoid valve SLT and the linear solenoid valve SLU.

The ECU 200 realizes various controls on the basis of the signals from the aforementioned sensors. FIG. 2 selectively shows portions related to controls of the vehicle 1000 related to the embodiment among the various controls.

ECU 200 is a well-known computer having a central processing unit (CPU) 210, a ROM (read-only memory) 220 and a RAM (random access memory) 230. The ROM 220 stores control programs 221, a normal mode shift map 222 and a heat generation mode shift map 223. The RAM 230 has a setting area 230A.

The CPU 210 realizes various functional portions shown in FIG. 2 by executing the control programs 221 by utilizing the RAM 230. Concretely, the CPU 210 realizes the functions as an electric pump control portion 211, a vehicle speed detection portion 212, a shift control portion 213, a heat generation state determination portion 215, the command output portion 217, a first oil pressure calculation portion 218 and a second oil pressure calculation portion 219. The ECU 200 executes a shift map setting process described later.

The drive system control device 240 controls the driving of the engine 1 or the rotary electric machine 3 on the basis of a command value from the ECU 200. The ECU 200 sends command values for driving or stopping the engine 1 and/or the rotary electric machine 3 to the drive system control device 240 on the basis of the signals from the accelerator operation amount sensor 231, the shift lever sensor 234 and the brake pedal sensor 235.

The first oil pressure calculation portion 218 calculates the necessary line pressure P_{L} (needed oil pressure) for the automatic transmission 100 on the basis of the accelerator operation amount (demanded torque) acquired from the accelerator operation amount sensor 231 and the shift speed of the speed change mechanism 5 acquired from the shift control portion 213 which will be described in detail later.

The second oil pressure calculation portion 219 calculates the generated oil pressure of the mechanical pump MP on the basis of an input-shaft rotation speed signal from the input-shaft rotation speed sensor 232.

The command output portion 217 outputs to the electric pump EP a command that causes the electric pump EP to be driven so that a total of the oil pressures generated by the mechanical pump MP and the electric pump EP becomes greater than or equal to the needed oil pressure calculated by the first oil pressure calculation portion 218, in the case where the generated oil pressure calculated by the second oil pressure calculation portion 219 is smaller than the needed oil pressure calculated by the first oil pressure calculation portion 218 (the case of the situation 1 or the situation 2, i.e., the case where the necessary line pressure P_{L} cannot be secured by using only the mechanical pump MP). Hereinafter, this command will also be termed the electric pump drive command.

The electric pump control portion 211, on the basis of the command from the command output portion 217, drives the electric motor EPA by controlling the driver EPB so as to cause the electric motor EPA to generate such an oil pressure that the total of the oil pressure and the generated oil pressure of the mechanical pump MP becomes greater than or equal to the needed oil pressure.

The vehicle speed detection portion 212 detects the vehicle speed of the vehicle 1000 on the basis of an output-shaft rotation speed signal acquired from the output-shaft rotation speed sensor 233.

The shift control portion 213 sets a shift map for performing a shift determination in a shift map setting process described later. Concretely, the shift control portion 213 sets either one of the normal mode shift map 222 and the heat generation mode shift map 223 in the setting area 230A of the RAM 230. Details of this will be described in conjunction with the shift map setting process described later.

The shift control portion 213 performs a process described below on the basis of the accelerator operation amount (torque demand) acquired from the accelerator operation amount sensor 231 and the vehicle speed detected by the vehicle speed detection portion 212 in the case where the position of the shift lever acquired from the shift lever sensor 234 is the forward drive range. That is, with reference to the shift map (the normal mode shift map 222 or the heat generation mode shift map 223) set in the setting area 230A, the shift control portion 213 determines the shift speed (speed ratio) for the time of forward travel in the speed change mechanism 5. Then, the shift control portion 213 controls combinations of the engaged states/released states of the friction engagement elements (refer to FIG. 4) in the speed change mechanism 5 by sending control signals (command values) to the manual shift valve MV, the linear solenoid valve, etc. so that the speed change mechanism 5 realizes the determined shift speed. For example, in the case where the shift control portion 213 has determined that the shift speed is to be set to the fourth forward speed, the shift control portion 213 sends control signals to the various valves so that the clutch C1 and the clutch C2 are engaged.

In the case where the position of the shift lever is the reverse drive range, the shift control portion 213 determines that the reverse travel is to be performed, and sends to the various valves such control signals as to control the clutch C3 and the brake B2 to the engaged state in the speed change mechanism 5 (refer to FIG. 4). In the case where the position of the shift lever is the parking range or the neutral range, the shift control portion 213 determines that the parking state or the neutral state is to be accomplished, and sends to the various valves such control signals as to control all the friction engagement elements of the speed change mechanism 5 to the released state (refer to FIG. 4).

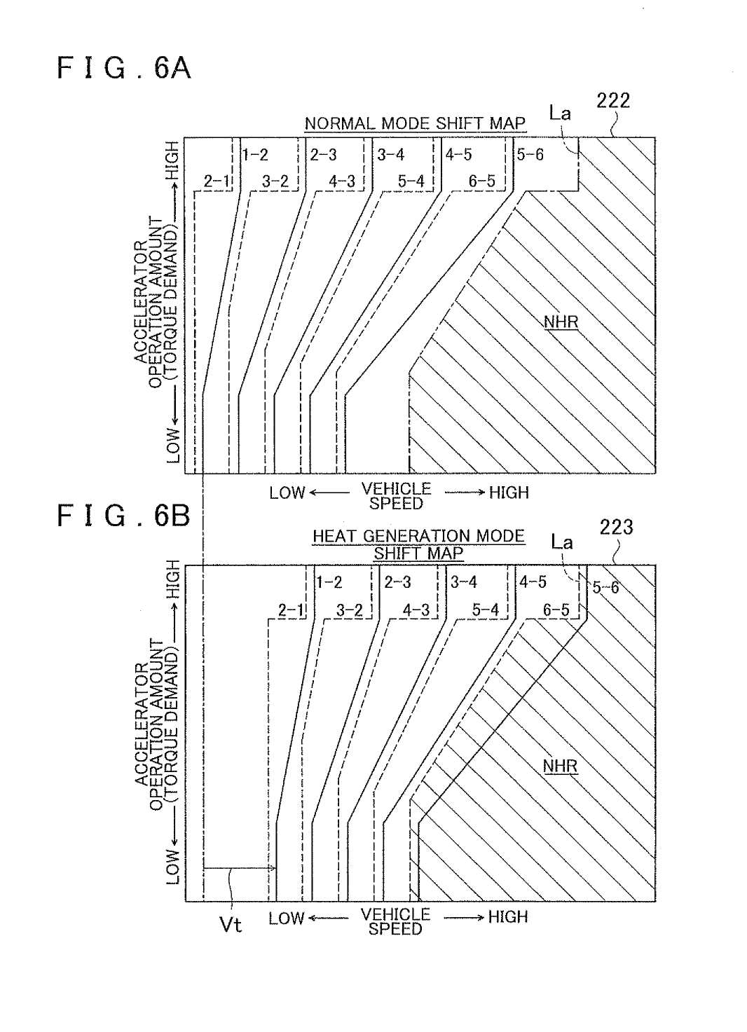

FIGS. 6A and 6B are schematic diagrams showing shift maps for use in the embodiment. Concretely, FIG. 6A shows the normal mode shift map 222, and FIG. 6B shows the heat generation mode shift map 223. As shown in FIGS. 6A and 6B, each shift map is a map in which shift lines are set as indexes (hereinafter, also termed the shift indexes) for performing the shift determination regarding the shift speed of the speed change mechanism 5 based on the accelerator operation amount (torque demand) and the vehicle speed. As shown in FIGS. 6A and 6B, in each shift map, a plurality of shift lines represented by substantially right-hand rising lines is set. Among the shift lines, upshift lines and downshift lines are set.

Herein, each upshift line is a line that represents a shift index for the shifting of the shift speed to a one-step higher shift speed in the case where the accelerator operation amount (torque demand) has decreased and/or the vehicle speed has increased, and is shown by a solid line in FIGS. 6A and 6B. As shown in FIGS. 6A and 6B, the characters represented by “n−(n+1)” (n is an integer of 1 to 5) and given near the upshift lines show that the nearby upshift lines are lines of the shifting from the nth forward speed to the (n+1)th forward speed. For example, in the case where “1-2” is given near an upshift line, it is indicated that the upshift line is a line of the shifting from the first forward speed to the second forward speed.

Besides, each downshift line is a line that represents a shift index of the shifting from the shift speed to a shift speed that is one step lower in the case where the accelerator operation amount (torque demand) has increased and/or the vehicle speed has decreased, and is shown by an interrupted line in FIGS. 6A and 6B. As shown in FIGS. 6A and 6B, the characters represented by “(n+1)−n” (n is an integer of 1 to 5) and given near the downshift lines show that the nearby upshift lines are lines of the shifting from the (n+1)th forward speed to the nth forward speed. For example, in the case where “2-1” is given near a downshift line, it is indicated that the downshift line is a line of the shifting from the second forward speed to the first forward speed.

As shown in FIG. 6B, each shift line in the heat generation mode shift map 223 is formed by translationally moving a shift line in the normal mode shift map 222, which represents a shift index for the same shift speed as the shift line in the heat generation mode shift map 223 (a shift line in the normal mode shift map 222 that corresponds to the shift line in the heat generation mode shift map 223) approximately by a movement amount Vt in a direction to higher vehicle speeds (a high vehicle speed side). In other words, in the heat generation mode shift map 223, the shift lines are formed such that the changing of the shift speed is made at higher vehicle speeds compared to the corresponding shift lines in the normal mode shift map 222 shown in FIG. 6A. Therefore, in the vehicle 1000, provided that the accelerator operation amount and the vehicle speed remain the same (hereinafter, also termed the same-travel state condition), there is a tendency of accomplishing a lower-side shift speed (higher speed ratio) in the case where the heat generation mode shift map 223 is used as a shift map by the shift control portion 213, in comparison with the case where the normal mode shift map 222 is used. As a result, in the vehicle 1000, in the case where in the same-travel state condition, the heat generation mode shift map 223 is used as a shift map by the shift control portion 213, it is possible to restrain decline in the rotation speed of the input shaft IN, so that the decline in the oil pressure generated by the mechanical pump MP can be restrained, in comparison with the case where the normal mode shift map 222 is used.

Besides, in the embodiment, the shift lines in the heat generation mode shift map 223 are set so that the necessary line pressure P_{L} (needed oil pressure) can be set by using the mechanical pump MP without driving the electric pump EP. In other words, in the case where one of the shift speeds excluding the first forward speed, that is, the lowest shift speed, has been realized in the speed change mechanism 5 and where the shift determination is being executed with reference to the normal mode shift map 222, if the shift control portion 213 performs the shift determination with reference to the heat generation mode shift map 223 in place of the normal mode shift map 222, a shift to a lower-side shift speed (such that the speed ratio heightens) is performed. The “necessary line pressure P_{L} (needed oil pressure)” in this case may be a maximum value of the line pressure that is needed in all the traveling situations of the vehicle 1000 that include the cases of the aforementioned situations 1 and 2. Besides, according to the travel situation, the necessary line pressure PL may also be an estimated value that is estimated as a line pressure that is needed at that time, or may also be a numerical value obtained by adding a margin to the estimated value. Incidentally, it can be said that “the aforementioned movement amount Vt is set so that the shift lines in the heat generation mode shift map 223 are disposed so that the necessary line pressure PL (needed oil pressure) can be secured by using the mechanical pump MP without driving the electrical pump EP”.

Incidentally, in the normal mode shift map 222 shown in FIG. 6A, a line La is shown by a one-dot chain line at a position that corresponds to the line La of the shifting from the sixth forward speed to the fifth forward speed in the heat generation mode shift map 223. The region to a high vehicle speed side of this line La in the normal mode shift map 222 is hereinafter termed the region NHR as well. In the case where the shift control is performed by using the normal mode shift map 222 and where the vehicle speed and the torque demand are both in the region NHR, performance of the shift control using the heat generation mode shift map 223 does not result in the performance of a downshift (the heightening of the speed ratio). However, the region NHR is a region in which the rotation speed of the input shaft IN can be sufficiently secured, and in which the necessary line pressure P_{L} (needed oil pressure) can be secured by using the mechanical pump MP. Therefore, in the case where the shift control is performed by using the normal mode shift map 222 and where the vehicle speed and the torque demand are both in the region NHR, the necessary oil pressure can be secured by using only the mechanical pump MP, so that it is not assumed that a heat generation condition is met.

The heat generation state determination portion 215 determines whether or not the heat generation condition regarding the electric ump EP is net in the shift map setting process described below. Besides, the heat generation state determination portion 215, in the shift map setting process, determines whether or not a discontinuation condition that allows it to be considered that the degree of heat generation of the electric pump EP has declined is met. Details of the heat generation condition and the discontinuation condition will be described later.

### A2. Shift Map Setting Process

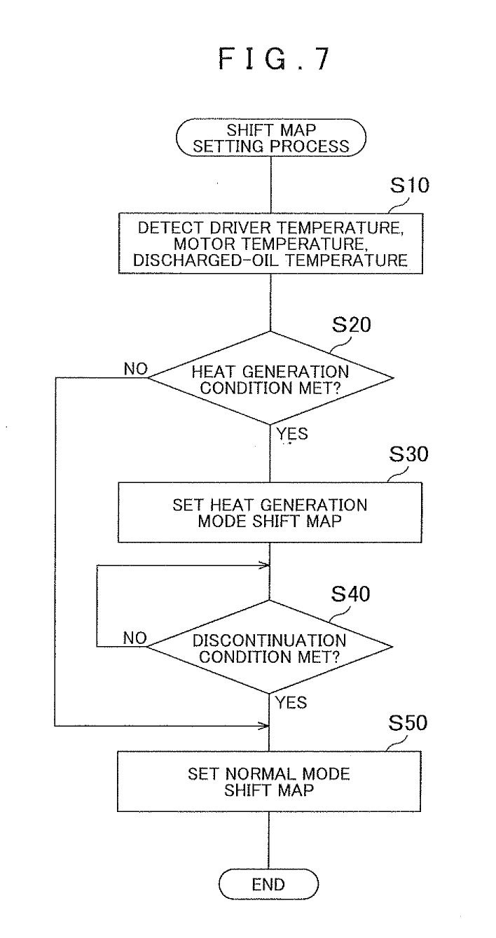

FIG. 7 is a flowchart of a shift map setting process that the ECU 200 of this embodiment performs. The ECU 200 executes this shift map setting process in the case where the electric pump drive command is output by the command output portion 217.

Hereinafter, the shift map setting process will be described with reference to FIG. 7. Incidentally, when the ECU 200 starts to execute this shift map setting process, the normal mode shift map 222 has been set in the setting area 230A.

In the shift map setting process, firstly the heat generation state determination portion 215 detects the driver temperature, the motor temperature and the discharged-oil temperature from the driver temperature sensor 11, the motor temperature sensor 12 and the oil temperature sensor 13 (step S10).

Next, the heat generation state determination portion 215 determines whether or not the heat generation condition is met from the detected driver temperature, the detected motor temperature and the detected discharged-oil temperature (step S20). Concretely, the heat generation state determination portion 215 determines that the heat generation condition is met, in the case where any one of the conditions 1 to 3 stated below is met. In the case where none of the conditions 1 to 3 is met, the heat generation state determination portion 215 determines that the heat generation condition is not met.

Threshold values T1, T2 and T3 mentioned below are determined as appropriate by a concrete design of the vehicle 1000.

Condition 1: the driver temperature is higher than the threshold value T1.
Condition 2: the motor temperature is higher than the threshold value T2.
Condition 3: the discharged-oil temperature is higher than the threshold value T3.

Incidentally, a reason why satisfaction of the condition 1 is set as a sufficient condition for the satisfaction of the heat generation condition is as follows. That is, the driver temperature is obtained by directly detecting the temperature of the driver EPB, and the driver temperature that is higher than the threshold value T1 means that the electric pump EP actually generates heat. Besides, a reason why satisfaction of the condition 2 is set as a sufficient condition for the satisfaction of the heat generation condition is as follows. That is, the motor temperature is detected by directly detecting the temperature of the electric motor EPA, and the motor temperature that is higher than the threshold value T2 means that the electric pump EP actually generates heat. Furthermore, a reason why satisfaction of the condition 3 is set as a sufficient condition for the satisfaction of the heat generation condition is as follows. That is, the discharged-oil temperature being higher than the threshold value T3 means that a viscosity of the operating oil is lower than a predetermined value. Therefore, great load is applied to the electric pump EP for the generation of the necessary oil pressure. As a result, the electric motor EPA and the driver EPB of the electric pump EP generate heat, giving rise to a possibility of an increase in the temperature of the electric pump EP.

Thus, the heat generation condition is a condition that includes the case where the temperature of one of the elements of the electric pump EP is actually high as in the aforementioned conditions 1 and 2 and also the case where it can be inferred that the temperature of one of the elements of the electric pump EP will become high in the near future as in the condition 3.

The shift control portion 213, if the heat generation state determination portion 215 determines that the heat generation condition is met (YES in step S20), sets the heat generation mode shift map 223 in the setting area 230A in place of the normal mode shift map 222 (step S30). In this case, the shift control portion 213 executes the shift determination with reference to the heat generation mode shift map 223. Therefore, in the case where one of the shift speeds excluding the first forward speed, that is, the lowest shift speed, has been realized in the speed change mechanism 5 immediately before the heat generation mode shift map 223 is set in replace of the normal mode shift map 222, the shift control portion 213 causes a shift to a low speed-side shift speed (such that the speed ratio increases). As a result, the oil pressure control device 10 can secure the necessary line pressure P_{L} (needed oil pressure) by using only the oil pressure generated by the mechanical pump MP. Hence, in this case, the electric pump control unit 211 does not drive the electric pump EP.

Subsequently, the heat generation state determination portion 215 determines whether or not the discontinuation condition that allows it to be considered that the degree of heat generation of the electric pump EP has declined is met (step S40). Concretely, the heat generation state determination portion 215 determines that the discontinuation condition is met in the case where all conditions A to C stated below are met, and determines that the discontinuation condition is not met in the case where any one of the conditions A to C is unmet. A threshold value T4 mentioned below is a value that is lower than the threshold T1. A threshold value T5 mentioned below is a value that is lower than the threshold value T2. A threshold value T6 mentioned below is a value that is lower than the threshold value T3. These threshold values T4, T5 and T6 are determined as appropriate by a concrete design of the vehicle 1000.

Condition A: the driver temperature has become lower than the threshold value T4.
Condition B: the motor temperature has become lower than the threshold value T5.
Condition C: the discharged-oil temperature has become lower than the threshold value T6.

In the case where the heat generation state determination portion 215 has determined that the discontinuation condition that allows it to be considered that the degree of heat generation of the electric pump EP has declined is met (YES in step S40), the shift control portion 213 sets the normal mode shift map 222 in the setting area 230A in place of the heat generation mode shift map 223 (step S50). In this case, the shift control portion 213 executes a proper shift determination with reference to the normal mode shift map 222. Therefore, the oil pressure control device 10 is sometimes not able to secure the necessary line pressure P_{L} (needed oil pressure) by using only the oil pressure generated by the mechanical pump MP. In such a case, the electric pump control portion 211 drives the electric pump EP in order to secure the necessary line pressure P_{L} (needed oil pressure), on the basis of a command from the common output portion 217. After the process of step S50 ends, the shift control portion 213 ends this shift map setting process.

In the case where the heat generation state determination portion 215 has determined that the discontinuation condition that allows it to be considered that the degree of heat generation of the electric pump EP has declined is not met (NO in step S40), the heat generation state determination portion 215 executes the process of step S40 until the discontinuation condition is met.

In the case where the heat generation state determination portion 215 has determined that the heat generation condition is not met (NO in step S20), the heat generation state determination portion 215 leaves the normal mode shift map 222 set in the setting area 230A (step S50), and ends this shift map setting process.

As in above, in the vehicle 1000 of this embodiment, in the case where in the shift map setting process (see FIG. 7), the heat generation state determination portion 215 has determined that the heat generation condition is met (YES in step S20), the shift control portion 213 causes the speed ratio of the speed change mechanism 5 to be higher than the speed ratio occurring when the determination portion 215 determines that the heat generation condition is met. According to this structure, the rotation speed of the drive force source (input shaft IN) can be increased, and therefore the oil pressure generated by the mechanical pump MP can be increased. Therefore, in the case where the heat generation condition regarding the electric pump EP is met, the load on the electric pump EP assisting the mechanical pump MP can be lightened. As a result, the heat generation of the electric pump EP can be restrained. Besides, in the case where the heat generation state determination portion 215 has determined that the heat generation condition is met (YES in step S20), the shift control portion 213 causes the speed ratio of the speed change mechanism 5 to be higher than the speed ratio occurring when the determination portion determines that the heat generation condition is met. Therefore, it is possible to increase the rotation speed of the drive force source (input shaft IN) and restrain the rise in the rotation speed of the output shaft OUT of the speed change mechanism 5. As a result, it is possible to restrain an uncomfortable feeling from being given to the driver of the vehicle. Besides, since the rotation speed of the drive force source is increased by heightening the speed ratio, the uncomfortable feeling associated with the increase of the rotation speed of the drive force source independent of operation of the driver of the vehicle and changes of the environment in which the vehicle travels can be restrained from being given to the driver of the vehicle. That is, according to the foregoing vehicle, in the case where the heat generation state determination portion 215 has determined that the heat generation condition is met, it is possible to restrain an uncomfortable feeling from being given to the driver of the vehicle and perform a countermeasure against the heat generation of the electric pump EP.

Besides, the shift control portion 213 is able to execute the shift control with reference to the heat generation mode shift map 223 whose shift lines have been shifted from those of the normal mode shift map 222 so that the rotation speed of the input shaft IN commensurate with the speed ratio that is determined on the basis of the vehicle speed and the demanded torque is higher than the rotation speed of the input shaft IN commensurate with the speed ratio that is determined on the basis of the vehicle speed and the demanded torque with reference to the normal mode shift map 222. Then, in the case where in the shift map setting process (see FIG. 7), the heat generation state determination portion 215 has determined that the heat generation condition is met (YES in step S20) during execution of the shift control with reference to the normal mode shift map 222, the shift control portion 213 executes the shift control with reference to the heat generation mode shift map 223 in place of the normal mode shift map 222. According to this structure, in the case where the heat generation condition is met during execution of the shift control based on the normal mode shift map 222, the shift control portion 213 switches to the shift control based on the heat generation mode shift map 223 whose shift lines have been shifted so that the rotation speed of the input shaft IN is higher than the rotation speed thereof determined with reference to the normal mode shift map 222, so as to restrain the decline in the oil pressure generated by the mechanical pump MP. As a result, in the case where the heat generation condition is met during execution of the shift control based on the normal mode shift map 222, the load on the electric pump EP can be at least lightened. Therefore, the heat generation of the electric pump EP can be restrained. Besides, no matter which one of the shift speeds (speed ratios) of the speed change mechanism 5 the present shift speed (speed ratio) is during execution of the shift control based on the normal mode shift map 222, the shift control portion 213 is able to easily increase the speed ratio and therefore increase the rotation speed of the drive force source (the input shaft IN) by switching to the shift control based on the heat generation mode shift map 223. Therefore, this structure makes it possible to restrain the heat generation of the electric pump EP through an easier and simpler control.

Furthermore, in the case where the heat generation condition is satisfied (YES in step S20) in the shift map setting process (refer to FIG. 7), the shift control portion 213 changes the shift map to be referred to in the shift control from the normal mode shift map 222 to the heat generation mode shift map 223 (step S30). After that, in the case where the discontinuation condition that allows it to be considered that the degree of heat generation of the electric pump EP has declined is met (YES in step S40), the shift control portion 213 returns the shift map that is to be referred to in the shift control from the heat generation mode shift map 223 to the normal mode shift map 222 (step S50). According to this structure, in the case where the degree of heat generation of the electric pump EP has declined, the shift control portion 213 is able to shift a portion of the load related to oil pressure generation that the mechanical pump MP bears to the electric pump EP, by shifting the increased speed ratio to a speed ratio that is proper in the state of the vehicle 1000. Therefore, the driving of the drive force source for the purpose of raising the rotation speed of the mechanical pump MP can be reduced by an amount that corresponds to the driving of the electric pump EP. As a result, improvement of the fuel economy of the vehicle can be expected.

Besides, in the heat generation mode shift map 223, the shift lines are set so that the line pressure P_{L} that the shift mechanism 5 needs (needed oil pressure) can be secured by using the mechanical pump MP without driving the electric pump ER

According to this structure, in the case where the electric pump EP generates heat, the shift control portion 213 can stop the electric pump EP because the needed oil pressure can be secured by using only the mechanical pump MP. As a result, the heat generation of the electric pump EP can be prevented.

Furthermore, in the case where the heat generation condition is met (YES in step S20) in the shift map setting process (refer to FIG. 7) in the case where one of the shift speeds excluding the first forward speed, that is, the lowest shift speed, has been accomplished in the speed change mechanism 5, the shift control portion 213 executes the setting of the heat generation mode shift map 223 in place of the normal mode shift map 222, and therefore causes a shift to a lower-side shift speed (such that the speed ratio increases). According to this structure, in the case where the heat generation condition is met, the shift control portion 213 performs a so-called downshift, so that the rotation speed of the input shaft IN can be increased and therefore the oil pressure that the mechanical pump MP generates can be increased. As a result, when the heat generation condition is met, the load on the electric pump EP can be at least lightened. Therefore, the heat generation of the electric pump EP can be restrained.

In this embodiment, the ECU 200 corresponds to a control device for an automatic transmission in the claims, and the heat generation state determination portion 215 corresponds to a determination portion in the claims, and the normal mode shift map 222 corresponds to a first shift map in the claims, and the heat generation mode shift map 223 corresponds to a second shift map in the claims.

### B. Second Embodiment

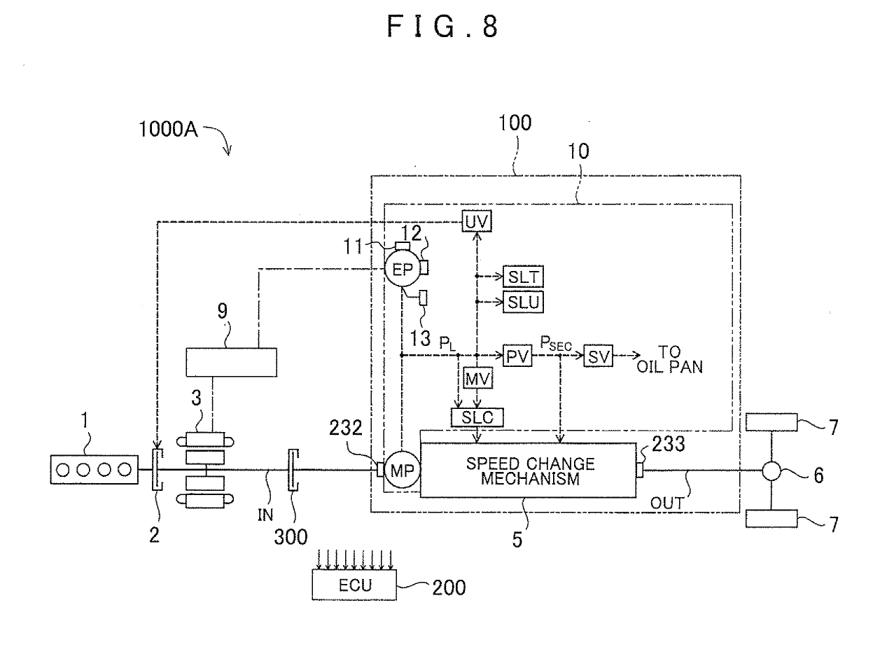

FIG. 8 is a diagram schematically showing a structure of a vehicle 1000A of a second embodiment. The vehicle 1000A of the second embodiment differs in structure from the vehicle 1000 of the first embodiment in having a transfer clutch 300. In the vehicle 1000A, the structures excluding the transfer clutch 300 are substantially the same as those of the first embodiment. In the vehicle 1000A, the same structures as those of the vehicle 1000 of the first embodiment are denoted by the same reference characters as used for the vehicle 1000, and the description thereof will be omitted.

In the vehicle 1000A, the transfer clutch 300 is disposed on an input shaft IN between a rotary electric machine 3 and a mechanical pump MP. The transfer clutch 300 is supplied with oil pressure transferred from a transfer clutch control valve (not shown) of an oil pressure control device 10, and is thereby controlled to an engaged state or a released state. The transfer clutch control valve receives input of a line pressure P_{L}, and regulates the line pressure P_{L} according to a signal pressure from a linear solenoid valve (not shown), and transfers it to a hydraulic servo of the transfer clutch 300, so as to control the transfer clutch 300.

The transfer clutch 300, during the traveling of the vehicle 1000A, is basically caused to be in the engaged state, and therefore transfers the drive force transferred from a drive force source (an engine 1 or the rotary electric machine 3) to a speed change mechanism 5 via the input shaft IN. The transfer clutch 300 is controlled to the released state, for example, in the case where the remaining amount of electric power in an electricity storage device 9 is less than a predetermined value. In this case, the ECU 200 firstly causes the transfer clutch 2 to be in the engaged state, and causes the rotary electric machine 3 to function as a motor, and therefore drives the engine 1. Then, the ECU 200, after raising the rotation speed of the engine 1 to a predetermined value, causes the rotary electric machine 3 to function as a generator, and therefore charges the electricity storage device 9 with the generated electric power.

The vehicle 1000A of the second embodiment achieves substantially the same operation and effects as the first embodiment and, furthermore, is capable of executing the driving of the engine 1 through the use of the rotary electric machine 3 and the charging of the electricity storage device 9 by causing the transfer clutch 300 to be in the released state.

### C. Third Embodiment

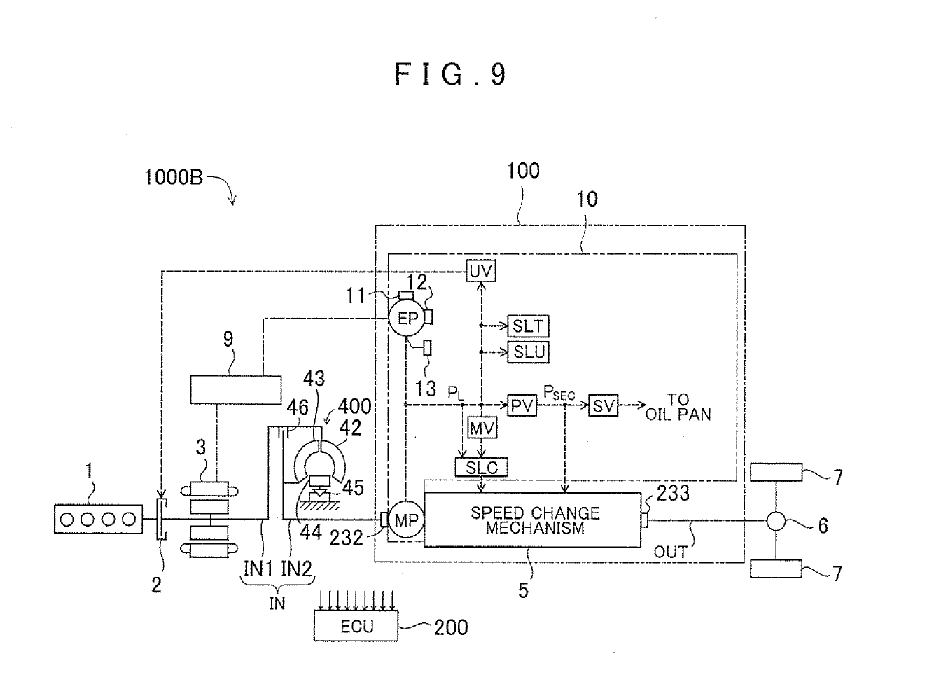

FIG. 9 is a diagram schematically showing a structure of a vehicle 1000B of a third embodiment. The vehicle 1000B of the third embodiment differs in structure from the vehicle 1000 of the first embodiment in having a torque converter 400. In the vehicle 1000B, the structures excluding the torque converter 400 are substantially the same as those of the vehicle 1000 of the first embodiment. In the vehicle 1000B, the same structures as those of the vehicle 1000 of the first embodiment are denoted by the same reference characters as used for the vehicle 1000, and the description thereof will be omitted.

In the vehicle 1000B, an input shaft IN is formed of an input shaft IN 1 and an input shaft IN2. The input shaft IN1 is linked to a rotary electric machine 3, and the input shaft IN2 is linked to a speed change mechanism 5.

The torque converter 400 is furnished with a pump impeller 42, a turbine runner 43, a stator 44, a one-way clutch 45, and a lockup clutch 46. The pump impeller 42 is linked to the input shaft IN1. The turbine runner 43 is linked to the input shaft 1N2. As the pump impeller 42 rotates together with the input shaft IN1, the rotation is transferred to the turbine runner 43 by the operating oil. The stator 44 is disposed between the pump impeller 42 and the turbine runner 43 so as to be rotatable only in one way due to the one-way clutch 45, and amplifies the torque of rotation transferred from the pump impeller 42 to the turbine runner 43. The lockup clutch 46 is a clutch capable of engaging the input shaft IN1 and the input shaft IN2 together. When the lockup clutch 46 is caused to be in the engaged state, the rotation of the input shaft IN1 is transferred to the input shaft IN2 without the intervention of the pump impeller 42 and the turbine runner 43.

The lockup clutch 46 receives supply of the operating oil from a lockup control valve (not shown) of an oil pressure control device 10, and is thereby controlled to the engaged state or the released state. The lockup control valve receives input of a line pressure P_{L}, and regulates the line pressure P_{L} according to a signal pressure from a linear solenoid valve (not shown), and transfers it to a hydraulic servo of the lockup clutch 46, so as to control the lockup clutch 46.

The lockup clutch 46 is controlled to the released state, for example, at the time of a standing start of the vehicle 1000B (e.g., the time when the speed change mechanism 5 is at the first forward speed), the time of change of the shift speed (the time of gear shift), etc., and, at the time of the other manners of travel, is controlled to the engaged state.

According to the vehicle 1000B of the third embodiment, the following operation and effects are obtained in addition to the same operation and effects as those of the vehicle of the first embodiment. That is, according to the vehicle 1000B, since the lockup clutch 46 of the torque converter 400 is controlled to the released state at the time of the standing start of the vehicle 1000B (e.g., the time when the speed change mechanism 5 is at the first forward speed), the time of the changing of the shift speed (the time of gear shift), etc., smooth standing start of the vehicle 1000B and smooth gear shift can be executed. Besides, according to the vehicle 1000B, the lockup clutch 46 is controlled to the engaged state in the vehicle 1000B at the time of travel other than the time of the standing start (e.g., the time when the speed change mechanism 5 is at the first forward speed) and the time of the changing of the shift speed (the time of gear shift), the drive force can be transferred directly from the input shaft IN1 to the input shaft IN2, and therefore improvement of the fuel economy of the vehicle 1000B can be expected.

### D. Fourth Embodiment

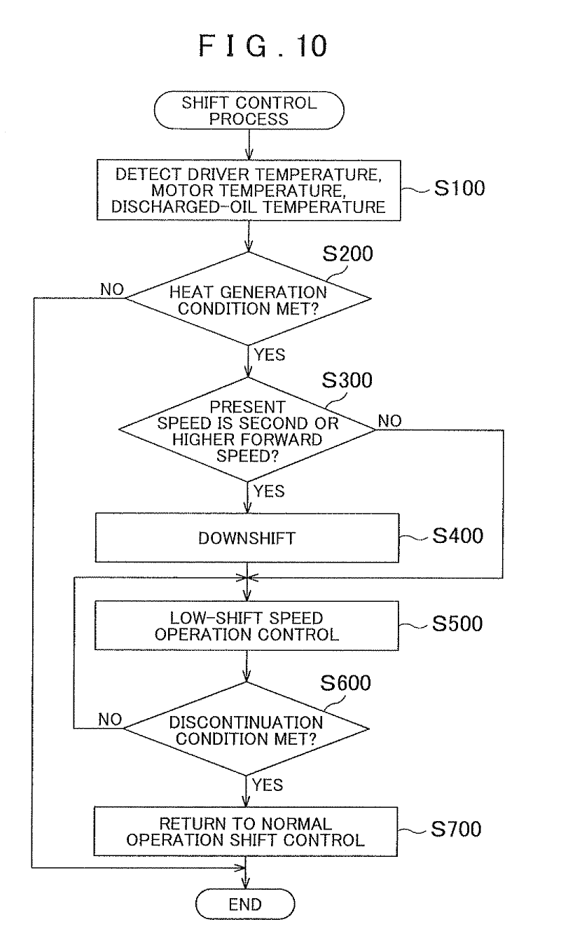

FIG. 10 is a flowchart showing process steps of a shift control setting process that is performed in a fourth embodiment. While the foregoing embodiments show examples in which the speed shift characteristic is changed by using the normal mode shift map 222 and the heat generation mode shift map 223, an example in which the speed shift characteristic is changed by using only the normal mode shift map 222 will be described as the fourth embodiment. In a vehicle of the fourth embodiment, the ECU 200 periodically executes the shift control setting process shown in FIG. 10 in place of the shift map setting process of the first embodiment when an normal shift control (a shift control pursuant to the normal mode shift map 222) is being performed. In the vehicle of the fourth embodiment, the heat generation mode shift map 223 of the first embodiment shown in FIG. 2 is not provided for use, the normal mode shift map 222 is set all the time in the setting area 230A of the RAM 230.

In the shift control setting process, firstly, as in the first embodiment (step 10 in FIG. 7), the heat generation state determination portion 215 detects the driver temperature, the motor temperature and the discharged-oil temperature from the driver temperature sensor 11, the motor temperature sensor 12 and the oil temperature sensor 13 (step S100). Then, the heat generation state determination portion 215, as in the first embodiment (step 20 in FIG. 7), determines whether or not the heat generation condition is met, from the detected driver temperature, the detected motor temperature and the detected discharged-oil temperature (step S200).

In the case where the heat generation state determination portion 215 has determined that the heat generation condition is met (YES in step S200), the shift control portion 213 determines whether or not the present shift speed of the speed change mechanism 5 is the second or higher forward speed (step S300). In the case where the present shift speed of the speed change mechanism 5 is the second or higher forward speed (YES in step S300), the shift control portion 213 performs a downshift of one shift speed to a lower shift speed side (step S400), and then proceeds to the process of step S500. In the case where the present shift speed is not the second or higher forward speed, that is, the case where the present shift speed is the first forward speed, the shift control portion 213 directly proceeds to the process of step S500.

In the process of step S500, the shift control portion 213 changes the setting of the shift control from the normal shift control to a low-shift speed operation control. The low-shift speed operation control is a control that causes the speed change mechanism 5 to accomplish a shift speed that is lower by one gear speed than the shift speed that ought to be accomplished in the normal shift control, in the case where the second or higher forward speed ought to be accomplished in the normal shift control. That is, in the condition where the second forward speed is accomplished in the normal shift control, the first forward speed is accomplished in the low-shift speed operation control; in the condition where the third forward speed is accomplished in the normal shift control, the second forward speed is accomplished in the low-shift speed operation control; in the condition where the fourth forward speed is accomplished in the normal shift control, the third forward speed is accomplished in the low-shift speed operation control; in the condition where the fifth forward speed is accomplished in the normal shift control, the fourth forward speed is accomplished in the low-shift speed operation control; and in the condition where the sixth forward speed is accomplished in the normal shift control, the fifth forward speed is accomplished in the low-shift speed operation control. Incidentally, in the condition where the first forward speed is realized in the normal control, the shift control portion 213 keeps the shift speed at the first forward speed.

When the low-shift speed operation control has been set, the heat generation state determination portion 215, as in the first embodiment (step 40 in FIG. 7), determines whether or not the discontinuation condition that allows it to be considered that the degree of heat generation of the electric pump EP has declined is met (step S600).

In the case where the heat generation state determination portion 215 has determined that the discontinuation condition that allows it to be considered that the degree of heat generation of the electric pump EP has declined is met (YES in step S600), the shift control portion 213 changes the setting of the shift control from the low-shift speed operation control to the normal shift control (step S700). After the process of step S700 ends, the shift control portion 213 ends this shift map setting process.

In the case where the heat generation state determination portion 215 has determined that the discontinuation condition that allows it to be considered that the degree of heat generation of the electric pump EP has declined is not met (NO in step S600), the heat generation state determination portion 215 executes the process of step S600 until the discontinuation condition is met.

According to the vehicle of the fourth embodiment described above, in the case where the heat generation state determination portion 215 has determined that the heat generation condition is met (YES in step S200), if the speed change mechanism 5 is at the second or higher forward speed, a downshift is promptly performed to raise the rotation speed of the input shaft IN. As a result, the oil pressure generated by the mechanical pump MP is raised so that load on the electric pump EP can be lightened. Therefore, the heat generation of the electric pump EP can be restrained.

Besides, according to the vehicle of the fourth embodiment, in the case where the heat generation condition is met, the low-shift speed operation control is executed in place of the normal shift control until the discontinuation condition is met. As a result, in the case where the heat generation condition is met, the upshift is restrained until the discontinuation condition is met. Therefore, the decline in the rotation speed of the input shaft IN can be restrained. As a result, the decline in the oil pressure generated by the mechanical pump MP is restrained so that the load on the electric pump EP can be lightened. Therefore, the heat generation of the electric pump EP can be restrained.

Besides, according to the vehicle of the fourth embodiment, the shift control portion 213 executes the low-shift speed operation control that causes the speed change mechanism 5 to accomplish a shift speed that is lower by one shift speed than the shift speed that ought to be accomplished in the normal shift control in the case where the second or higher forward speed ought to be accomplished in the normal shift control. Therefore, since the control can be performed by using the same normal mode shift map 222 that is used in the normal shift control, there is not a need to provide the heat generation mode shift map 223 for use, and the heat generation of the electric pump EP can be restrained with a simple structure.

Incidentally, in the vehicle of the fourth embodiment, in the case where the heat generation state determination portion 215 has determined that the heat generation condition is met (YES in step S200), if the speed change mechanism 5 is at the second or higher forward speed, a downshift is promptly performed. However, the present invention is not limited to this. For example, when the speed change mechanism 5 is at the second or higher forward speed in the case where the heat generation state determination portion 215 determines that the heat generation condition is met (YES in step S200), a change in the rotation speed of the input shaft IN may be detected, and in the case where the rotation speed of the input shaft IN has declined, a downshift may be performed, and in the case where the rotation speed of the input shaft IN has remained the same or has risen, the downshift may be avoided.

### E. Modifications

Incidentally, of the component elements in the foregoing embodiments, the elements other than the elements claimed in the independent claim are additive elements, and can be omitted as appropriate. Besides, the present invention is not limited to the foregoing embodiments and modes for carrying out the invention, but can be carried out in various forms without departing from the scope of the present invention; for example, the following modifications are possible.

### E1. First Modification

In the foregoing embodiments, the shift lines of the heat generation mode shift map 223 are set so that the necessary line pressure P_{L} (needed oil pressure) can be secured by using the mechanical pump MP without driving the electric pump EP. However, the invention is not limited to this. For example, in the heat generation mode shift map, the shift lines may be structured so that the shift lines are shifted to the high vehicle speed side of the corresponding shift lines in the normal mode shift map 222 althrough the necessary line pressure P_{L} (needed oil pressure) cannot be secured by using the mechanical pump MP without driving the electric pump EP. According to this structure, in the case of the same-travel state condition, if the shift control portion 213 performs the shift control with reference to the heat generation mode shift map, the shift control portion 213 executes a downshift at an earlier timing than in the case where the shift control portion 213 performs the shift control with reference to the normal mode shift map 222. Specifically, in the case where the shift control is performed with reference to the heat generation mode shift map, the shift control portion 213 can restrain the decline in the rotation speed of the input shaft IN, in comparison with the case where the shift control is performed with reference to the normal mode shift map 222. Therefore, when the heat generation condition is met, the load on the electric pump EP can be lightened. As a result, the heat generation of the electric pump EP can be restrained.

### E2. Second Modification

Although in the foregoing embodiments and the foregoing modifications, the shift lines of the heat generation mode shift map 223 are structured by translationally moving the corresponding shift lines in the normal mode shift map 222 to the high vehicle speed side by about a movement amount Vt, the invention is not limited to this. For example, the shift lines of the heat generation mode shift map 223 may be structured by translationally moving the corresponding shift lines in the normal mode shift map 222 to the high vehicle speed side by respectively different movement amounts. In this case, the movement amounts of the shift lines in the heat generation mode shift map 223 may be set so that the individual shift lines are disposed so that the necessary line pressure P_{L} (needed oil pressure) can be secured by using the mechanical pump MP without driving the electric pump EP.

### E3. Third Modification

Although in the foregoing embodiments and the foregoing modifications, the shift lines of the heat generation mode shift map 223 are structured by translationally moving the corresponding shift lines in the normal mode shift map 222 to the high vehicle speed side, the invention is not limited to this. For example, in the heat generation mode shift map 223, at least a portion of each shift line may be structured by displacing it to the high vehicle speed side of a corresponding one of the shift lines in the normal mode shift map 222. Besides, in the heat generation mode shift map 223, at least a portion of one or more shift lines of the plurality of shift lines may be structured by displacing it to the high vehicle speed side of corresponding one or more of the shift lines in the normal mode shift map 222.

### E4. Fourth Modification

In the foregoing embodiments and the foregoing modifications, the ECU 200 may be designed so as to hold a heat generation mode shift map X1 in addition to the heat generation mode shift map 223. As for this heat generation mode shift map X1, for example, each of the shift lines is structured by translationally moving a corresponding one of the shift lines in the normal mode shift map 222 to the high vehicle speed side by a movement amount that is smaller than the movement amount Vt. The shift control portion 213, according to the heat generation state of the electric pump EP, selects a heat generation mode shift map from the heat generation mode shift map 223 and the heat generation mode shift map X1, and uses the map for the shift control. In this case, for example, in the case where none of the foregoing conditions 1 to 3 is met but where any of the following conditions 1A, 2A and 3A is met, the shift control portion 213 performs the shift control with reference to the heat generation mode shift map X1, and in the case where the foregoing heat generation condition is met, the shift control portion 213 performs the shift control with reference to the heat generation mode shift map 223.

Condition 1A: the driver temperature is higher than a threshold value T1A.
Condition 2A: the motor temperature is higher than a threshold value T2A.
Condition 3A: the discharged-oil temperature is higher than a threshold value T3A.

Incidentally, the threshold value T1A is a value that is lower than the threshold value T1, and the threshold value T2A is a value that is lower than the threshold value T2, and the threshold value T3A is a value that is lower than the threshold value T3.

Besides, the ECU 200 may also be designed so as to hold a plurality of heat generation mode shift maps in addition to the heat generation mode shift map 223. As for the plurality of heat generation mode shift maps, for example, the shift lines of each of the shift maps may be structured by translationally moving the corresponding shift lines in the normal mode shift map 222 to the high vehicle speed side by a movement amount that is smaller than the movement amount Vt. The plurality of heat generation mode shift maps is each structured so that the foregoing movement amount varies. In this case, the shift control portion 213, according to the heat generation state of the electric pump EP, selects a heat generation mode shift map from the heat generation mode shift map 223 and the plurality of heat generation mode shift maps, and uses the map for the shift control. For example, the shift control portion 213 selects a heat generation mode shift map with a larger movement amount as the degree of heat generation of the electric pump EP is higher.

### E5. Fifth Modification

Although the foregoing embodiments and the foregoing modifications adopt as the speed change mechanism 5 a stepped-speeds transmission capable of accomplishing a plurality of shift speeds, the invention is not limited to this. For example, as a speed change mechanism, a continuously variable transmission (CVT) capable of continuously changing the speed ratio may be adopted. In this case, the oil pressure generated by the oil pressure control device 10 is transferred to pulleys (not shown) of the speed change mechanism and to the clutches and brakes (not shown) provided for switching between the forward travel and the reverse travel, and is thus utilized for the shift control.

### E6. Sixth Modification

Although in the foregoing embodiment and the foregoing modifications, the shift control portion 213 is designed to perform the shift control with reference to the normal mode shift map 222 or the heat generation mode shift map 223, the invention is not limited to this. The shift control portion 213 may be designed so that, in the case where the shift control is performed, the shift control portion 213 performs the shift control on the basis of a function that prescribes shift indexes (hereinafter, also termed the shift index function) in place of the shift map. For example, the shift control portion 213 may also be designed so that, in the case where the shift control is performed with reference to the heat generation mode shift map 223, the shift control portion 213 performs the shift control on the basis of, in place of the heat generation mode shift map 223, shift index functions that correspond to the shift lines of the heat generation mode shift map 223.

### E7. Seventh Modification

Although in the foregoing embodiments or the foregoing modifications, the heat generation state determination portion 215 determines that the heat generation condition is met in the case where any one of the conditions 1 to 3 is met in the shift map setting process (refer to FIG. 7), the invention is not limited to this. For example, the heat generation state determination portion 215 may be designed to determine that the heat generation condition is met in the case where two or more of the foregoing conditions 1 to 3 are met. Besides, the heat generation state determination portion 215 may determine that the heat generation condition is met in the case where any one of the following conditions 4 to 6 is met, or may also determine that the heat generation condition is met in the case where any one of the foregoing conditions 1 to 3 and the following conditions 4 to 6 is met.

Condition 4: the continuous driving time of the electric motor EPA of the electric pump EP exceeds a threshold value T10.
Condition 5: the rotation speed of the electric pump EP exceeds a threshold value 11 and the continuous driving time in that state exceeds a threshold value T12.

Condition 6: the integral value of the electric current value of the driver EPB in a predetermined period exceeds a threshold value T13.

### E8. Eighth Modification

In the foregoing embodiments or the foregoing modifications, the heat generation state determination portion 215 determines that the discontinuation condition is met (YES in step S40) in the case where all the aforementioned conditions A to C are met in the shift map setting process (refer to FIG. 7), and determines that the discontinuation condition is not met (NO in step S40) in the case where any one of the aforementioned conditions A to C is unmet. However, the invention is not limited to this. For example, the heat generation state determination portion 215 may be designed so as to determine that the discontinuation condition is met in the case where a certain time elapses after the heat generation condition is met (after the process of step S20), and so as to determine that the discontinuation condition is not met in the case where the certain time has not elapsed.

### E9. Ninth Modification

Although in the foregoing embodiments or the foregoing modifications, the oil temperature sensor 13 is disposed at the discharge port of the electric pump EP and is designed so as to detect the oil temperature of the operating oil discharged from the electric pump EP, the invention is not limited to this. For example, the oil temperature sensor 13 may be disposed at a location in any one of the operating oil paths within a valve body (not shown) that accommodates therein the primary regulator valve PV, the secondary regulator valve SV, etc. In this case, the oil temperature sensor 13 sends the oil temperature at its disposed location as an oil temperature signal to the ECU 200. On the other hand, the heat generation state determination portion 215 uses the oil temperature based on the oil temperature signal sent thereto, for the determination about the heat generation condition or the discontinuation condition.

### E10. Tenth Modification

In the foregoing embodiments or the foregoing modifications, the shift control portion 213 is designed so that in the case where the shift control is performed with reference to the normal mode shift map 222 or the heat generation mode shift map 223, the shift control portion 213 performs the shift control with reference to the shift map set in the setting area 230A of the RAM 230. However, the invention is not limited to this. For example, the shift control portion 213 may be designed so as to perform the shift control with direct reference to a shift map stored in the ROM 220 on the basis of a shift map selection flag that shows which one of the normal mode shift map 222 and the heat generation mode shift map 223 ought to be referred to.

### E11. Eleventh Modification

Although the foregoing embodiments or the foregoing modifications adopt the automatic transmission 100 furnished with the speed change mechanism 5 of six forward speeds and one reverse speed that uses a single pinion type first planetary gear set PG1 and a Ravigneaux type second planetary gear set PG2, the invention is not limited to this. For example, well-known automatic transmissions of, for example, four forward speeds and one reverse speed, five forward speeds and one reverse speed, seven forward speeds and one reverse speed, eight forward speeds and one reverse speed, etc. Generally speaking, the invention is applicable to any automatic transmission that is disposed on a power transfer path from a drive source of a vehicle to a driving wheel thereof, that has a plurality of friction engagement elements, an input shaft and an output shaft, and that is capable of accomplishing a plurality of shift speeds that give respectively different speed ratios that are ratios between the rotation speed of the input shaft and the rotation speed of the output shaft, according to the states of engagement of the plurality of friction engagement elements.

### E12, Twelfth Modification

Although in the foregoing embodiments and the foregoing modifications, the ECU 200 is realized by one computer, the above-described functions of the ECU 200 may be realized by cooperation of a plurality of computers. For example, the functions of the ECU 200 may be realized by cooperation of a main ECU that controls the vehicle 1000 overall and an A/T ECU that performs a control of the automatic transmission 100. In this case, it is possible to arbitrarily set which functions of the ECU 200 are to be taken by which one of the ECUs. Besides, although the functions of the ECU 200 are realized by the CPU 210 executing the control programs 221, the whole or part of the structure that is realized by the aforementioned software may be replaced with hardware circuits. For example, the functions of the electric pump control portion 211 shown in FIG. 2 may be realized by hardware circuits that have logic circuits.

### E13. Thirteenth Modification

Although in the foregoing embodiments and the foregoing modifications, the rotary electric machine 3 is capable of functioning as both a motor and a generator, the invention is not limited to this. For example, the rotary electric machine 3 may be furnished with only the generator function without being furnished with the motor function, and may also be furnished with only the motor function without being furnished with the generator function. Besides, the vehicle may have a structure in which the rotary electric machine 3 is omitted.

### E14. Fourteenth Modification

In the foregoing embodiments or the foregoing modifications, the command output portion 217 is designed so as to output an electric pump drive command such that the total of the oil pressures generated by the mechanical pump MP and the electric pump EP becomes equal to the needed oil pressure in the case where the generated oil pressure calculated by the second oil pressure calculation portion 219 is smaller than the needed oil pressure calculated by the first oil pressure calculation portion 218. However, the invention is not limited to this. For example, the ECU 200 may be furnished with a predetermined map (hereinafter, also termed the electric pump-generated oil pressure map) that makes it possible for the electric pump EP to output the oil pressure that ought to be generated, by inputting the accelerator operation amount (demanded torque) from the accelerator operation amount sensor 231, the shift speed of the speed change mechanism 5 from the shift control portion 213, the input-shaft rotation speed signal from the input-shaft rotation speed sensor 232, etc. Then, the command output portion 217 may be designed so as to output an electric pump drive command such that the total of the oil pressures generated by the mechanical pump MP and the electric pump EP becomes equal to the needed oil pressure, on the basis of the electric pump-generated oil pressure map. According to this structure, there is no need to provide the first oil pressure calculation portion 218 or the second oil pressure calculation portion 219, but the needed oil pressure can be secured with a simple structure by using the electric pump EP.

The invention can be suitably utilized for a control device for an automatic transmission that changes the rotation speed transferred from a drive force source of the vehicle to the input shaft and then transfers it to the output shaft.

What is claimed is:

1. A control device for an automatic transmission that changes rotation speed transferred from a drive force source of a vehicle to an input shaft and then transfers the rotation speed to the output shaft, the automatic transmission having: a speed change mechanism that changes a speed ratio that represents a ratio of the rotation speed of the input shaft to the rotation speed of the output shaft by utilizing oil pressure; a mechanical pump that is driven by rotation of the input shaft and that generates the oil pressure for changing the speed ratio of the speed change mechanism; and an electric pump that is driven independently of the drive force source by using electric power and that generates the oil pressure for changing the speed ratio of the speed change mechanism together with the generated oil pressure from the mechanical pump, the control device for the automatic transmission being comprising:
a command output portion that outputs a command that causes the electric pump to be driven so that the oil pressure generated by the mechanical pump and the electric pump becomes greater than or equal to a needed oil pressure of the speed change mechanism in a case where the oil pressure generated by the mechanical pump is smaller than the needed oil pressure;
a determination portion that determines whether or not a predetermined heat generation condition regarding the electric pump is met, in a case where the command is output by the command output portion; and
a shift control portion that, in a case where the determination portion has determined that the heat generation condition is met, performs a shift control of causing the speed ratio of the speed change mechanism to become higher than the speed ratio occurring when the determination portion determines that the heat generation condition is met.

2. The control device for the automatic transmission according to claim 1, wherein
the determination portion determines whether or not a discontinuation condition that allows it to be considered that degree of heat generation of the electric pump has declined is met, after the shift control portion performs the shift control of causing the speed ratio of the speed change mechanism to become higher, and
the shift control portion shifts to a speed ratio that is proper in a state of the vehicle, in a case where the determination portion has determined that the discontinuation condition is met.

3. The control device for the automatic transmission according to claim 2, wherein
the shift control portion is capable of executing:
a first shift control of performing the shift control based on a first shift map that includes a plurality of shift lines defined by a relationship between vehicle speed and demanded torque; and
a second shift control of performing the shift control based on a second shift map which includes a plurality of shift lines defined by a relationship between the vehicle speed and the demanded torque, and in which at least a portion of each shift line is shifted to a high vehicle speed side of a corresponding one of the shift lines of the first shift map so that the rotation speed of the input shaft commensurate with the speed ratio determined based on the vehicle speed and the demanded torque is higher than the rotation speed of the input shaft commensurate with the speed ratio determined based on the vehicle speed and the demanded torque with reference to the first shift map, and that
in a case where during execution of the first shift control, the determination portion has determined that the heat generation condition is met, the control device executes the second shift control in place of the first shift control.

4. The control device for the automatic transmission according to claim 3, wherein
in the second shift map, the plurality of shift lines are set so that the needed oil pressure that the speed change mechanism needs is able to be secured by using the mechanical pump without driving the electric pump.

5. The control device for the automatic transmission according to claim 1, wherein
the shift control portion is capable of executing:
a first shift control of performing the shift control based on a first shift map that includes a plurality of shift lines defined by a relationship between vehicle speed and demanded torque; and
a second shift control of performing the shift control based on a second shift map which includes a plurality of shift lines defined by a relationship between the vehicle speed and the demanded torque, and in which at least a portion of each shift line is shifted to a high vehicle speed side of a corresponding one of the shift lines of the first shift map so that the rotation speed of the input shaft commensurate with the speed ratio determined based on the vehicle speed and the demanded torque is higher than the rotation speed of the input shaft commensurate with the speed ratio determined based on the vehicle speed and the demanded torque with reference to the first shift map, and that
in a case where during execution of the first shift control, the determination portion has determined that the heat generation condition is met, the control device executes the second shift control in place of the first shift control.

6. The control device for the automatic transmission according to claim 5, wherein
in the second shift map, the plurality of shift lines are set so that the needed oil pressure that the speed change mechanism needs is able to be secured by using the mechanical pump without driving the electric pump.
